(19) United States
(12) Patent Application Publication
(10) Pub. No.: US 2015/0254358 A1
(43) Pub. Date: Sep. 10, 2015

(54) DEVICE TASK SUGGESTION GENERATOR

(71) Applicant: Lenovo (Singapore) Pte. Ltd., Singapore (SG)

(72) Inventors: Russell Speight VanBlon, Raleigh, NC (US); Shirley Mary McKenna, Raleigh, NC (US); Caroline Helen Lalla, Cary, NC (US)

(73) Assignee: Lenovo (Singapore) Pte. Ltd., Singapore (SG)

(21) Appl. No.: 14/199,405

(22) Filed: Mar. 6, 2014

(51) Int. Cl. G06F 17/30; G06F 9/445; H04L 29/08

(52) U.S. Cl. CPC G06F 17/30867; H04L 67/22; G06F 8/61; G06F 17/30876

(57) ABSTRACT

A method includes tracking user interaction with a device, correlating tracked interactions with a feature not yet enabled on the device, and providing the user with a task to enable the feature on the device.

### BACKGROUND

Many devices, such as computers have thousands of features that may be activated or downloaded. Many users set up their own devices, and may not be aware of all these functions. Thus users may utilize perhaps a small set of these features and functions

### SUMMARY

A method includes tracking user interaction with a device, correlating tracked interactions with a feature not yet enabled on the device, and providing the user with a task to enable the feature on the device.

A machine readable storage device having instructions for execution by a processor of the machine to perform tracking user interaction with a device, correlating tracked interactions with a feature not yet enabled on the device, and providing the user with a task to enable the feature on the device.

A device includes a processor and a memory device having a program stored thereon for execution by the processor to track user interaction with a device, correlate tracked interactions with a feature not yet enabled on the device, and provide the user with a task to enable the feature on the device.

### BRIEF DESCRIPTION OF THE DRAWINGS

FIG. 1 is a flowchart illustrating a method of generating tasks for a device according to an example embodiment.

FIG. 2 is a block diagram of a system for generating tasks for a device according to an example embodiment.

FIG. 3 is a block diagram of computer system used to implement methods according to an example embodiment.

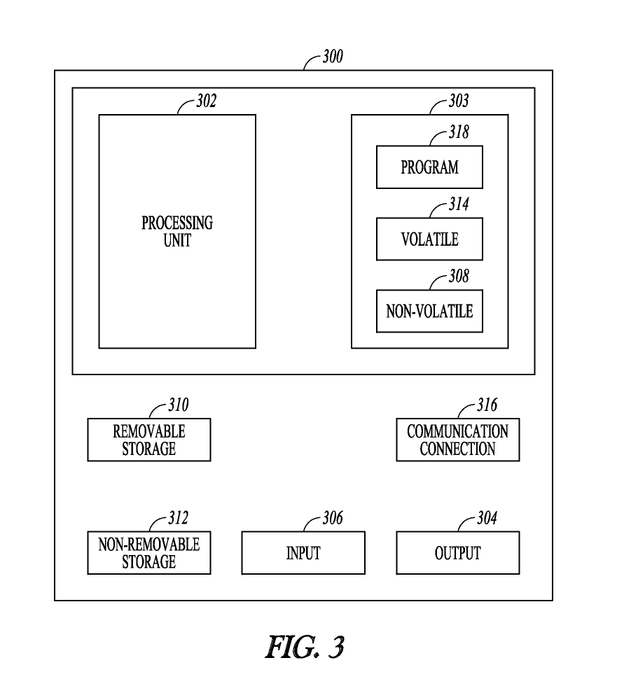

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

Following set up of a new device, tasks may be suggested to a user to add or activate features as a function of use of the device. In one embodiment, the tasks are suggested based on the behavior of the user in using the device. Tasks may be logically grouped and associated with specific behaviors in using the device. Feature that the user may not care about may be identified and not shown to the user. The user may also indicate features that they like or dislike via positive or negative indication, such as by using a thumb's up or a thumb's down icon.

Tasks may be brought to the attention of a user via multiple different methods, such as toast messages, widget messages, notifications, dynamic in-app content, and others. In one example, after a user sets up a device and uses it, the device may detect that the user has taken several pictures. Depending on the number of pictures taken, the user may be provided with a suggested task of installing either a high function photo editing program such as Photo Shop, or a lower function program such as MS Paint. If a significant number of pictures, such as 1000 or more, appear to have been taken or otherwise obtained, the high function photo editing program may be suggested, whereas if a lower number of pictures have been obtained, a lower function photo handling program may be suggested.

Similarly, if a user frequently uses photo related software, content, such as articles and suggested software may be provided to the user, whereas if no photos or photo related software has been utilized by the user, only basic photo related content may be provided.

In one example, a new user may first set up network communications, such as WiFi functions, and soon thereafter set up one or more email accounts, and begin web surfing. Based on these actions, one task suggested may be the installation of an antivirus program. Later, the user may be prompted to select a power and battery management profile based on use of the device, such as a smart phone. A suggested profile may be provided in some embodiments, or the user may be provided access to a profile set up screen. Likes and dislikes expressed by a user may also be tracked and used to select or suppress suggestions. The device may also track time since initial set up of the device and suggests tasks or content related to adding memory or even suggesting a new device at an end of life cycle of the device occurs. In another example, after two years of use, the user may be prompted with a suggested task of changing a battery.

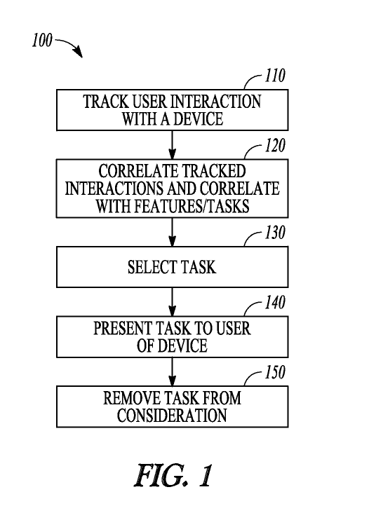

FIG. 1 is a flowchart illustrating a method 100 of generating tasks. At 110, the device tracks user interaction with the device. The user interactions may include information related to use of functions of the device such as a camera used to take pictures and movies, use of email, text messaging, various social media, telephone functions, features enabled, apps used, software applications used, and others. At 120, the device may send the data to a remote server for processing to correlate the user interactions to potential tasks and content. Such tasks and content may be tagged with different types of user interactions to help with such correlation via simple table lookup, expert system, neural network, or other types of programs suitable for performing such correlations. In some embodiments, correlations may be performed on the device, or by both the device and the server.

At 130, one or more of the correlated tasks and/or content may be selected and provided to the user at 140. The presentation may be performed periodically in some embodiments, such as daily or weekly to ensure the user is not inundated with such tasks and/or content. Tasks may be removed from consideration once completed as indicated at 150, or optionally based user preferences via observed behavior as well as user indicated likes and dislikes.

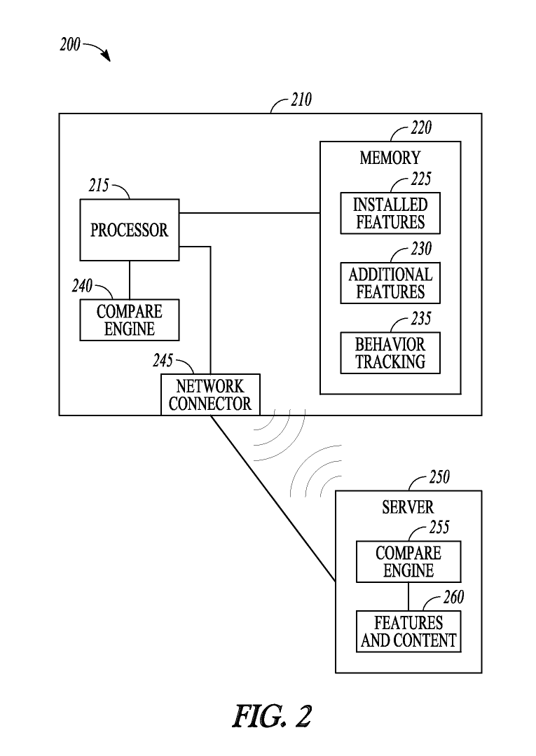

FIG. 2 is a block diagram of a system 200 to provide task suggestions to users. A device 210 in various embodiments may be a mobile device, such as a laptop computer, smart phone, or tablet, or may be a desk top computer or other device capable of operating with multiple optional features. In one embodiment, device 210 includes a processor 215 and a memory 220. The memory may include software for multiple installed features 225 for execution by processor 215.

Additional features that have not yet been installed or activated are indicated at 230. An area for storing information related to behavior tracking is illustrated at 235, and may include information regarding feature utilization and other behaviors as indicated above, and optionally user expressed likes and dislikes. The information may include statistical information in some embodiments, such as information indicating quantity and frequency of feature and data utilization by a user of the device 210. In one embodiment, the behavior tracking information 235 includes information corresponding to thresholds of behavior established for additional feature notification to users, and may easily be compared at a compare engine 240, which may be coupled to or a part of processor 215. The thresholds of behavior corresponding to the additional features may be stored with the additional features 230, or in a separate table accessible by compare engine 240.

In further embodiments, a network connector 245 may be coupled to the processor 215 to facilitate communications with a remote server 250 which may also have transceiver or other network connection. The network connector 245 may be a wireless transponder, hardwired connection, or other type of connection suitable for providing a connection to a remote server via a network. Server 250 may also contain a compare engine 255 coupled to obtain additional features and content at 260. Server 250 may obtain behavior tracking information 235 from the device 210, and may also track behavior based on interactions of the user via the device 210 with the server 250.

FIG. 4 is a block schematic diagram of a computer system 400 to implement device 100 and other computing resources according to example embodiments. All components need not be used in various embodiments. One example computing device in the form of a computer 400, may include a processing unit 402, memory 403, removable storage 410, and non-removable storage 412. Sensors 115 and 125 may be coupled to provide data to the processing unit 402. Memory 403 may include volatile memory 414 and non-volatile memory 408. Computer 400 may include—or have access to a computing environment that Includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 400 may include or have access to a computing environment that includes input 406, output 404, and a communication connection 416. Output 404 may include a display device, such as a touchscreen, that also may serve as an input device. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 400. A hard drive, CD-ROM, and RAM are some examples of articles including a non-transitory computer-readable medium. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

### EXAMPLES

1. A method comprising:
tracking user interaction with a device;
correlating tracked interactions with a feature not yet enabled on the device; and
providing the user with a task to enable the feature on the device.

2. The method of example 1 wherein providing the user with the task comprises presenting a message to the user identifying the task.

3. The method of any of examples 1-2 wherein providing the user with the task comprises presenting a notification to the user.

4. The method of any of examples 1-3 wherein the features comprise software based functions for installation on the device.

5. The method of any of examples 1-4 wherein interaction tracking comprises tracking user interactions with photographs, and wherein the task comprises a prompt to install an advanced photo handling software product.

6. The method of any of examples 1-5 wherein correlating tracked interactions with a feature not yet installed comprises:
collecting data corresponding to the tracked interactions; and
comparing the collected data with data corresponding to the not yet installed features.

7. The method of any of examples 1-6 wherein comparing the collected data with the data corresponding to the not yet installed features comprises using an expert system to perform the comparison.

8. The method of any of examples 1-7 and further comprising:
collecting data corresponding to the tracked interactions;
sending the collected data to a remote server; and
receiving information from the remote server related to the collected data.

9. The method of example 8 wherein collecting data comprises tracking an age of the system and wherein the received information comprises a suggestion for a new device at an end of life cycle of the device.

10. The method of example 9 wherein the received information comprises content related to the tracked interactions.

11. A machine readable storage device having instructions for execution by a processor of the machine to perform:
tracking user interaction with a device;
correlating tracked interactions with a feature not yet enabled on the device; and
providing the user with a task to enable the feature on the device.

12. The machine readable storage device of example 11 wherein providing the user with the task comprises presenting a message to the user identifying the task.

13. The machine readable storage device of any of examples 11-12 wherein the features comprise software based functions for installation on the device.

14. The machine readable storage device of any of examples 11-13 wherein interaction tracking comprises tracking user interactions with photographs, and wherein the task comprises a prompt to install an advanced photo handling software product.

15. The machine readable storage device of any of examples 11-14 wherein correlating tracked interactions with a feature not yet installed comprises:
collecting data corresponding to the tracked interactions; and
comparing the collected data with data corresponding to the not yet installed features.

16. The machine readable storage device of any of examples 1-15 wherein the instructions further comprise:
collecting data corresponding to the tracked interactions;
sending the collected data to a remote server; and
receiving information from the remote server related to the collected data.

17. A device comprising:
a processor; and
a memory device having a program stored thereon for execution by the processor to:
   track user interaction with a device;
   correlate tracked interactions with a feature not yet enabled on the device; and
   provide the user with a task to enable the feature on the device.

18. The device of example 17 wherein tracked interaction comprises user interactions with photographs, and wherein the task comprises a prompt to install an advanced photo handling software product.

19. The device of any of examples 17-18 wherein correlated tracked interactions with a feature not yet installed comprises:
collecting data corresponding to the tracked interactions; and
comparing the collected data with data corresponding to the not yet installed features.

20. The device of any of examples 17-19 wherein the program is further to cause the processor to:
collect data corresponding to the tracked interactions;
send the collected data to a remote server; and
receive information from the remote server related to the collected data.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
tracking user interaction with a device;
correlating tracked interactions with a feature not yet enabled on the device; and
providing the user with a task to enable the feature on the device.

2. The method of claim 1 wherein providing the user with the task comprises presenting a message to the user identifying the task.

3. The method of claim 1 wherein providing the user with the task comprises presenting a notification to the user.

4. The method of claim 1 wherein the features comprise software based functions for installation on the device.

5. The method of claim 1 wherein interaction tracking comprises tracking user interactions with photographs, and wherein the task comprises a prompt to install an advanced photo handling software product.

6. The method of claim 1 wherein correlating tracked interactions with a feature not yet installed comprises:
collecting data corresponding to the tracked interactions; and
comparing the collected data with data corresponding to the not yet installed features.

7. The method of claim 1 wherein comparing the collected data with the data corresponding to the not yet installed features comprises using an expert system to perform the comparison.

8. The method of claim 1 and further comprising:
collecting data corresponding to the tracked interactions;
sending the collected data to a remote server; and
receiving information from the remote server related to the collected data.

9. The method of claim 8 wherein collecting data comprises tracking an age of the system and wherein the received information comprises a suggestion for a new device at an end of life cycle of the device.

10. The method of claim 9 wherein the received information comprises content related to the tracked interactions.

11. A machine readable storage device having instructions for execution by a processor of the machine to perform:
tracking user interaction with a device;
correlating tracked interactions with a feature not yet enabled on the device; and
providing the user with a task to enable the feature on the device.

12. The machine readable storage device of claim 11 wherein providing the user with the task comprises presenting a message to the user identifying the task.

13. The machine readable storage device of claim 11 wherein the features comprise software based functions for installation on the device.

14. The machine readable storage device of claim 11 wherein interaction tracking comprises tracking user interactions with photographs, and wherein the task comprises a prompt to install an advanced photo handling software product.

15. The machine readable storage device of claim 11 wherein correlating tracked interactions with a feature not yet installed comprises:
collecting data corresponding to the tracked interactions; and
comparing the collected data with data corresponding to the not yet installed features.

16. The machine readable storage device of claim 1 wherein the instructions further comprise:
collecting data corresponding to the tracked interactions;
sending the collected data to a remote server; and
receiving information from the remote server related to the collected data.

17. A device comprising:
a processor; and
a memory device having a program stored thereon for execution by the processor to:
track user interaction with a device;
correlate tracked interactions with a feature not yet enabled on the device; and
provide the user with a task to enable the feature on the device.

18. The device of claim 17 wherein tracked interaction comprises user interactions with photographs, and wherein the task comprises a prompt to install an advanced photo handling software product.

19. The device of claim 17 wherein correlated tracked interactions with a feature not yet installed comprises:
collecting data corresponding to the tracked interactions; and
comparing the collected data with data corresponding to the not yet installed features.

20. The device of claim 17 wherein the program is further to cause the processor to:
collect data corresponding to the tracked interactions;
send the collected data to a remote server; and
receive information from the remote server related to the collected data.
